(19) United States
(12) Patent Application Publication
(10) Pub. No.: US 2018/0075415 A1
(43) Pub. Date: Mar. 15, 2018

(54) SEMI-AUTOMATED JOB MATCH SYSTEM AND METHOD

(71) Applicants: James A. Ray, Groton, MA (US); Long Bao Pham, Ho Chi Minh City (VN)

(72) Inventors: James A. Ray, Groton, MA (US); Long Bao Pham, Ho Chi Minh City (VN)

(21) Appl. No.: 15/262,783

(22) Filed: Sep. 12, 2016

(51) Int. Cl. G06Q 10/10; G06F 17/30

(52) U.S. Cl. CPC G06Q 10/1053; G06F 17/30241

(57) ABSTRACT

A method of matching a job-seeking driver with a driving job is implemented with the aid of a data-processing system including a computer memory and a job-match algorithm. The data-processing system receives data relating to driver jobs for which drivers are sought and stores in the computer memory a uniquely-identifiable job-data file corresponding to each driver job for which data has been received. Additionally, the data-processing system receives driver-related data associated with job-seeking drivers and stores in the computer memory a uniquely-identifiable driver-data file corresponding to each job-seeking driver for which data has been received. A stored job-date file is algorithmically matched with a stored driver-data file based on a predetermined set of job-match threshold criteria. Information relating to a stored job-date file to which a driver-date file is algorithmically matched is rendered available to the driver associated with the driver-date file through an output interface.

### PROVISIONAL PRIORITY CLAIM

Priority based on Provisional Application, Ser. No. 62/217,497 filed Sep. 11, 2015, and entitled “SEMI-AUTOMATED JOB MATCH SYSTEM AND METHOD” is claimed. Moreover, the entirety of the previous provisional application, including the drawings, is incorporated herein by reference as if set forth fully in the present application.

### BACKGROUND

Participants in the trucking industry are faced with the challenge of matching qualified and available drivers with suitable trucking routes for which trucker/carriers are seeking drivers. From the perspective of a driver, searching for a job route through examination of traditional classified job listings is cumbersome, frustrating and extremely time-consuming. Traditional listings are difficult to search, read and compare.

Although job posting and searching has increasingly moved beyond the exclusive use of traditional print advertising in media such as newspapers, job postings on the internet using services such as Craigslist and JobsinTrucks, for example, are still accompanied by many of the same limitations as print ads. For instance, while an internet job search employing keywords helps narrow geographic locations and other basic attributes associated with jobs, the search returns are still generally in the form of classified ads of differing formats containing variable, non-uniform information across disparate ads. Frequently, a job seeker will need to visit individual carrier websites and click links within such websites to learn more about a single job route. Moreover, the job seeker may be required to place one or more telephone calls per “candidate job listing” in order to ascertain whether the advertised job is a viable potential match for him or her. Using the available tools, successful job searches can require weeks or months, crucial time during which a driver is not receiving an income.

From the perspective of a carrier, messaging to and identifying promising driver candidates can be equally daunting and time-consuming. Additionally, carriers waste funds on misplaced ads that are not seen by qualified candidates. As a hedge against limited, misplaced exposure, carriers rely in part on the redundancy provided by placing multiple ads for the same position in multiple outlets. For instance, dedicated carrier personnel are paid to determine the optimal use of advertising dollars by studying specific driver routes and identifying where best to post a specific job along a given route. Although internet postings are most likely involved nowadays, the manually-intensive process of studying selected routes and making ad placement decisions is arduous, imprecise and commensurately expensive.

Based on the preceding, it will be appreciated that current methods of driver-job searching and carrier-route posting result in substantial wasted time and effort for job-seeking drivers and time, effort and funds for driver-seeking carrier/truckers. Accordingly, a need exists for a more automated, streamlined and predictable system and method for filtering and matching qualified truck drivers with trucker/carriers.

### SUMMARY

A semi-automated method of matching a human job-seeking driver with a driving job is illustratively implemented in conjunction with a provided data-processing system with an associated, communicatively-linked computer memory and a job-match algorithm. Job data relating to a plurality of field-specific jobs for which employees are sought are received by the data-processing system through at least one employer-input device communicatively-linked to the data-processing system. A uniquely-identifiable job-data file corresponding to each job for which data has been received into the data-processing system is stored thereby in the computer memory.

The data-processing system further receives through at least one communicatively-linked driver-input device driver-related data associated with a plurality of job-seeking drivers. A uniquely-identifiable driver-data file corresponding to each job-seeking driver for which driver data has been received is stored in the computer memory.

A stored job-data file is algorithmically matched by the job-match algorithm with at least one stored driver-data file based on a predetermined, but updatable, set of job-match threshold criteria. Information relating to at least one stored job-data file for which a matching driver-data file has been algorithmically identified is rendered available to at least the human job-seeking driver associated with that driver-data file through a machine-to-human output interface for at least one of display, saving, and printing, by way of example. Typically, though not exclusively, the machine-to-human output interface will be one and the same device with the driver-input device.

In various implementation, among the information rendered available to at least one job-seeking driver for which a job-match has been algorithmically identified is a graphic display including a geographic map indicative of at least one of (i) a road, (ii) a starting point, (iii) an endpoint, and (iv) a geographic region associated with the matched job-data file. In at least one version, the displayed geographic map further includes interactive job markers superimposed upon the geographic map. Each the job markers is indicative of at least one job associated with a job-data file to which the job-seeking driver has been algorithmically matched.

In at least one version implemented in a commercial truck-driving environment in which the employers are commercial-trucking “carriers” and the employees sought are commercial truck drivers, each stored job-data file includes data indicative of a predetermined, carrier-established set of truck-driver attributes sought by the carrier associated with that job-data file. Illustratively, the carrier-established truck-driver attributes are selected from among (i) truck-operator licenses obtained; (ii) duration of experience; (iii) types of trucks previously driven; (iv) endorsements and certifications; (v) possession of access documents; (vi) experience with specific transportation equipment and technology; (vii) experience with cargo types; (viii) experience in specific terrain settings; (ix) experience and knowledge of safety requirements and procedures; (x) history or transportation-related incidences; (xi) history of legal incidences; (xii) employment history; (xiii) geographical preferences; and (xiv) experience with specific cargo loading and unloading equipment.

In addition to the preceding, at least some implementations facilitate a carrier's defining and associating with a job-data file a carrier-customized geographic hiring area. In alternative versions, a carrier-customized geographic hiring area can be illustratively defined with reference to at least one of (i) a corridor of, between, and including at least two geographic locales, wherein the corridor could be defined, for example, in terms of traversable roads; (ii) a circle of predefined radius centered on a single geographic locale; (iii) at least one geographic hub and spoke set; (iv) the geographic boundary of a governmental entity, including, for example, regions, such a “mid-west, “New England,” “Connecticut,” “Middlesex County, Mass.,” etc.; and (v) a manually-drawn irregular shape superimposed upon a map. The latter—a manually-drawn irregular shape—may be drawn on a screen displaying a map with the use of an electronic pen, for example.

Each stored driver-data file is associated with a human truck driver and includes data indicative of a predetermined set of driver-possessed attributes. Among the data relating to driver-possessed attributes are data relevant to carrier-established truck-driver attributes sought by carriers and included within stored job-data files. However, in addition to driver-possessed attributes relating to carrier-established truck-driver attributes associated with job-data files, at least one implementation permits a driver-data file to include data indicative of driver-desired job attributes sought by the human truck driver associated with that driver-data file. Non-limitingly illustrative of driver-desired attributes that might be associated with a human's driver-data file are (i) geographic parameters; (ii) days of the week required; (iii) hours required; (iv) salary parameters; (v) vacation parameters; (vi) healthcare-benefit parameters; and (vii) retirement plan parameters.

Representative embodiments are more completely described and depicted in the following detailed description and the accompanying drawings.

### BRIEF DESCRIPTION OF THE DRAWINGS

FIG. 1 schematically depicts an illustrative communications and data-processing architecture for the implementation semi-automated methods for filtering and job-matching qualified truck drivers with trucker/carriers.

### DETAILED DESCRIPTION

The following description of variously implemented semi-automated job-match systems and methods, and associated architecture, is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to constrict the maximum scope of the claims.

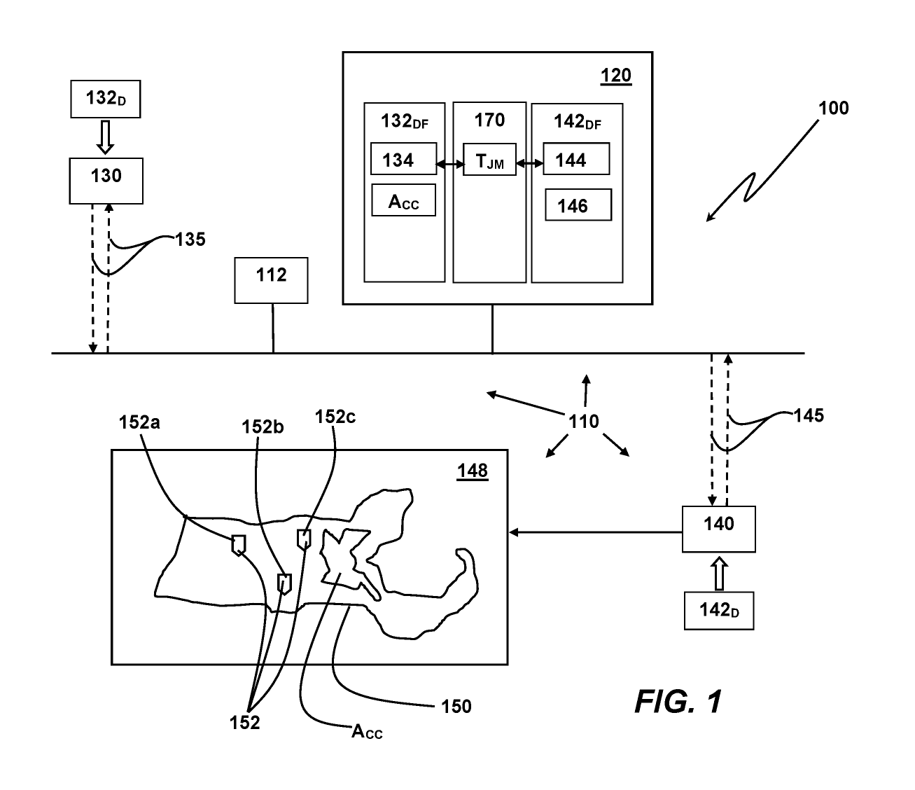

Referring to the function-block schematic of FIG. 1, an illustrative implementation of a job-match system 100 includes access to a data processing system 110. The data processing system 110 includes a central processing unit (CPU, or, simply “processor) 112 that is communicatively linked to a computer memory 120. Received into the data-processing system 110 through at least one employer-input device 130 are job data 132_{D} relating to a plurality of field-specific jobs for which employees are sought. Each employer-input device 130 is communicatively linked to the data-processing system 110 by a hardwired and/or wireless communication link 135 (dashed line) and could include, by way of non-limiting example, a personal computer, a cellular telephone or a so-called “tablet” device. A uniquely-identifiable job-data file 132_{DF} corresponding to each job for which job data 132_{D} has been received is stored in the computer memory 120.

Although the job-match system 100 is hereinafter described with principal reference to commercial driver jobs for which commercial drivers are sought, it understood that the system 100 may be equally applied to alternative job-matching environments of which the trucking and transportation industry is only one illustrative, but highly relevant example discussed for the purpose of providing concrete context. In the illustrative trucking context, the employers are hereinafter referred to as “carriers,” the jobs being offered are “driver jobs,” and job-seeking employees (job candidates) is sought by the carriers are alternatively referred to as “drivers,” “truck drivers” or “commercial drivers.”

With continued reference to FIG. 1, the data-processing system 110 further receives through at least one driver-input device 140 driver-related data 142_{D} associated with a plurality of job-seeking drivers. Each driver-input device 140 is communicatively linked to the data-processing system 110 by a hardwired or wireless communication link 145 (dashed line) and could include, by way of non-limiting example, a personal computer, a cellular telephone or a so-called “tablet” device. A uniquely-identifiable driver-data file 142_{DF} corresponding to each job-seeking driver for which driver data 142_{D} has been received is stored in the computer memory 120.

As shown in the architecture schematic of FIG. 1, a set of job-match algorithms 170 is part of, or is otherwise rendered accessible to, the data-processing system 110. The job-match algorithms 170 apply job-match threshold criteria T_{JM} in order to identify compatibility between, and algorithmically match, stored job-data files 132_{DF} and stored driver-data files 142_{DF}. In various implementations, an algorithmic job match is indicated between a job-data file 132_{DF} and a driver-data file 142_{DF} based, at least in part, on an algorithmic comparison of a carrier-established set of desired truck-driver attributes 134 sought by the carrier associated with the job-data file 132_{DF} and driver-possessed attributes 144 included in the driver-data file 142_{DF}, and, more specifically, on whether the compatibility between truck-driver attributes 134 and driver-possessed attributes 144 meets a predetermined set of job-match threshold criteria T_{JM}. The nature and details of the aforesaid attributes vary greatly among implementations, but some examples are provided later in this description.

Information relating to a stored job-data file 132_{DF} for which a stored driver-data file 142_{DF} has been algorithmically identified as a match is rendered available to the human job-seeking driver associated with the stored driver-data file 142_{DF} through a machine-to-human output interface 140. It will, of course, be readily appreciated that the machine-to-human output interface 140 can be one and the same device with the is driver-input device 140, but need not be. For purposes of illustration, they are treated as the same device (140) in FIG.1.

Typically, the information rendered available to the job-seeking driver will be so rendered through a graphic display 148 on, or otherwise communicatively associated with, the machine-to-human output interface 140. In variously implementations, the graphic display 148 includes a geographic map 150 (alternatively referred to as a job map 150) indicative of at least one—but more usually several—of (i) a road, (ii) a starting point, (iii) an endpoint, and a geographic region associated with the matched job-data file 132_{DF}, by way of example. The displayed geographic map 150 further includes interactive job markers 152 superimposed upon the geographic map 150.

Each job marker 152 (e.g., 152a, 152b and 152c in the map 150 of Massachusetts in FIG. 1) is indicative of at least one job associated with a job-data file 132_{DF} to which a driver-data file 142_{DF} associated with a job-seeking driver has been algorithmically matched. When a job marker 152 is highlighted (e.g., scrolled over or clicked) by the job-seeking driver to whom the geographic map 150 is displayed, information associated with the job-data file 132_{DF} to which that job marker 152 corresponds is displayed on the machine-to-human output interface 140. A job marker 152 itself can be indicative of a company name and/or company logo. So, for example, a displayed geographic map 150 including multiple superimposed job markers 152 might include job markers 152 associated with jobs available in the relevant geographic region at FedEx®, Yellow Freight®, United Parcel Service, etc. Accordingly, the job-seeking driver can, in the first instance, highlight job markers 152 associated with carriers for whom he is most interested in exploring first.

As previously indicated, a job match will be indicated when there is met or exceeded a predetermined job-match threshold T_{JM} of compatibility between carrier-desired truck-driver attributes 134 and driver-possessed attributes 144 as reflected in, respectively, a job-data file 132_{DF} and a driver-data file 142_{DF}. Although these attributes 134 and 144 may vary substantially across job types and hiring environments, even within the trucking and transport industry, an illustrative, non-limiting set of examples includes: (a) licenses possessed, (b) endorsements and certifications, (c) possession of access documents, (d) experience level with specific types of transportation equipment and/or transportation technology including vehicle types, cargo-securement procedures and equipment, etc., (e) experience with disparate types of cargo (e.g., livestock, machinery, construction equipment, liquids and gases, hazardous materials, etc.), (f) experience in different geographical and terrain settings (e.g., icy roads, mountains, urban, etc.), (g) education related to job duties, (h) experience with and knowledge of safety requirements and procedures, (i) index/history of transportation-related incidences (e.g., accidents, tickets/citations, and out-of-service violations, (j) index/history of legal incidences (e.g., failed drug tests, felonies, drug-related convictions, and DUI/OUI), (k) employment history, (l) governmental scoring type(s), (m) geographical preferences, (n) military experience, and (o) cargo loading and unloading equipment (e.g., forklifts, cranes, LIONS).

In addition to a carrier-established set of truck-driver attributes 134 sought by an employer/carrier, various implementations allow a carrier to associate with each job-data file 132_{DF} a carrier-customized geographic hiring area A_{CC}. A carrier-customized geographic hiring area A_{CC} can be defined with reference to at least one of (i) a corridor between and including at least two geographic locales, wherein the corridor could be defined in terms of traversable roads, (ii) a circle of predefined radius centered on a single geographic locale, (iii) the geographic boundary of a governmental entity, such as a city, county, or state, (iv) a geographic region such as “New England,” “mid-Atlantic,” “mid-west,” etc.). In one particularly robust version, a carrier can superimpose upon a job map 150 associated with a job-data file 132_{DF} a manually-drawn irregular shape to define the carrier-customized geographic hiring area A_{CC}, an illustrative example of which is shown in the geographic map 150 shown on the graphic display 148 depicted in FIG. 1. Alternative implementations permit a carrier to define and superimpose upon a job map associated with a job-data file 132_{DF} a carrier-customized geographic hiring area A_{CC} with reference to a combination of the techniques previously described in this paragraph. Moreover, a job map 150 including such a carrier-customized geographic hiring area A_{CC} will, in various versions, be part of the graphically-displayed data rendered available to a job-seeking driver to whom the job-data file 132_{DF} has been job matched.

In still addition implementations, in order to further enhance and refine the algorithmic job-match identification, a job-seeking driver can associate with his or her driver-data file 142_{DF} not just driver-possessed attributes 144 relating to truck-driver attributes 134 sought by carriers, but also data indicative of driver-desired job attributes 146 sought by him or her. A non-exhaustive, illustrative list of driver-desired job attribute data 146 includes: (a) geographical preferences, (b) compensation and benefits details, (c) compensation methods and pay period (e.g., electronic payment weekly, paper check monthly, etc.), (d) compensation basis such as hourly, salary, by mile, etc. (e) home time preferences, (f) transportation equipment preferences, (g) transportation technology preferences, (h) cargo preferences, (i) shipper preferences (j) work days and/or hours, (k) fleet culture and makeup, (l) insurance coverages, and (m) on-board equipment, such as computers.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. An automated method of matching a human job-seeking driver with a driving job, the method comprising:
providing a data-processing system including a computer memory;
receiving into the data-processing system data relating to a plurality of driver jobs for which drivers are sought;
storing in the computer memory a uniquely-identifiable job-data file corresponding to each driver job for which data has been received;
receiving into the data-processing system driver-related data associated with a plurality of job-seeking drivers;
storing in the computer memory a uniquely-identifiable driver-data file corresponding to each job-seeking driver for which data has been received;
algorithmically matching, based on a predetermined set of job-match threshold criteria, a stored job-data file with at least one stored driver-data file; and
rendering available to at least one human job-seeking driver associated with a stored driver-data file, through a machine-to-human output interface, information relating to at least one stored job-data file for which a match has been algorithmically identified.

2. The method of claim 1 wherein, among the information rendered available to the at least one job-seeking driver for which a match has been algorithmically identified is a graphic display including a geographic map indicative of at least one of (i) a road, (ii) a starting point, (iii) an endpoint, and (iv) a geographic region associated with the matched job-data file.

3. The method of claim 2 wherein the displayed geographic map further includes interactive job markers superimposed upon the geographic map, each of which job markers is indicative of at least one job associated with a job-data file to which the job-seeking driver has been algorithmically matched.

4. The method of claim 1 wherein the driver jobs are trucking jobs for which carriers associated with the stored job-data files are seeking human truck drivers.

5. The method of claim 4 wherein each stored job-data file includes data indicative of a predetermined, carrier-established set of truck-driver attributes sought by the carrier associated with that job-data file.

6. The method of claim 5 wherein the carrier-established set of truck-driver attributes sought by carriers associated with job-data files are selected from among the following truck-driver attributes:
(i) truck-operator licenses obtained;
(ii) duration of experience;
(iii) types of trucks previously driven;
(iv) endorsements and certifications;
(v) possession of access documents;
(vi) experience with specific transportation equipment and technology;
(vii) experience with cargo types;
(viii) experience in specific terrain settings;
(ix) experience and knowledge of safety requirements and procedures;
(x) history or transportation-related incidences;
(xi) history of legal incidences;
(xii) employment history;
(xiii) geographical preferences; and
(xiv) experience with specific cargo loading and unloading equipment.

7. The method of claim 6 wherein a carrier can define and associate with each job-data file a carrier-customized geographic hiring area.

8. The method of claim 7 wherein a carrier-customized geographic hiring area can be defined with reference to at least one of the following:
(i) a corridor of, between, and including at least two geographic locales;
(ii) a circle of predefined radius centered on a single geographic locale;
(iii) at least one hub and spoke set;
(iv) the geographic boundary of a governmental entity (draft note—in non-provisional, consider that this could also be regions like New England, midwest or mid-Atlantic, by way of non-limiting example); and
(v) a manually-drawn irregular shape superimposed upon a map.

9. The method of claim 8 wherein the carrier-customized geographic hiring area is defined with reference to at least two of the following:
(i) a corridor of, between, and including at least two geographic locales;
(ii) a circle of predefined radius centered on a single geographic locale;
(iii) at least one hub and spoke set;
(iv) the geographic boundary of a governmental entity; and
(v) a manually-drawn irregular shape superimposed upon a geogrpahic map.

10. The method of claim 6 wherein each stored driver-data file is associated with a human truck driver and includes data indicative of a predetermined set of driver-possessed attributes, wherein, among the data relating to driver-possessed attributes are data relevant to truck-driver attributes sought by carriers and included within stored job-data files.

11. The method of claim 10 wherein, in addition to driver-possessed attributes relating to truck-driver attributes sought by carriers associated with job-data files, each driver-data file includes data indicative of driver-desired job attributes sought by the human truck driver associated that driver-data file.

12. The method of claim 11 wherein driver-desired attributes associated with a driver-data file are selected from among the following driver-desired attributes:
(i) geographic parameters;
(ii) days of the week required;
(iii) hours required;
(iv) salary parameters;
(v) vacation parameters;
(vi) healthcare-benefit parameters; and
(vii) retirement plan parameters.

13. The method of claim 10 wherein each job-data file is algorithmically matched to a driver-data file on the basis of data within the job-data file relating to both a carrier-established set of truck-driver attributes and a set of geographic attributes.

14. The method of claim 13 wherein the set of geographic attributes includes data indicative of a carrier-customized geographic hiring area.
